(19) United States
(12) Patent Application Publication
(10) Pub. No.: US 2006/0156631 A1
(43) Pub. Date: Jul. 20, 2006

(54) Assembly support for a vehicle door

(76) Inventors: Rudi Koelle, Sindelfingen (DE); Martin Lindmayer, Sulz (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/522,108

(22) PCT Filed: Jul. 12, 2003
(86) PCT No.: PCT/EP03/07566

§ 371 Date: Aug. 24, 2005

(30) Foreign Application Priority Data
Jul. 24, 2002 (DE) 102335567

(51) Int. Cl. E05B 65/06

(52) U.S. Cl. 49/394

(57) ABSTRACT

An assembly support for a vehicle door of a passenger vehicle is equipped with a locking system. The assembly support is designed for fastening to the body shell of the vehicle door. A lock unit of the locking system is fastened to the assembly support. In order to simplify the assembly of the vehicle door, an outside actuating unit of the locking system is likewise fastened to the assembly support and/or to the lock unit, the outside actuating unit being coupled to the lock unit via an operative connection.

### BACKGROUND AND SUMMARY OF THE INVENTION

The present invention relates to an assembly support for a vehicle door equipped with a locking system of a passenger vehicle.

An assembly support of this type is known, for example, from German document DE 199 44 965 A1 and is designed for fastening to a body shell of the vehicle door. Assembly supports are suitable in particular for realizing a preassembly process, in which as many components as possible which are to be accommodated in the interior of the vehicle door are already attached to the assembly support. This enables a preassembled, complex subassembly to be provided which can be inserted in a relatively simple manner within the context of a final installation into the body shell of the vehicle door. A lock unit of the locking system, a window opening drive and speakers, for example, are fastened to the known assembly support.

The assembly of a vehicle door usually takes place in such a manner that an outside actuating unit of the locking system is fastened to an inner side of the body shell. The assembly support is then fitted into the body shell, the outside actuating unit then being coupled to the lock unit via a suitable operative connection, for example a Bowden cable. The locking system can then be tested and adjusted in order to be able to ensure that it functions correctly for the subsequent operation. This testing and adjustment of the locking system with the vehicle door assembled to this extent has proved relatively complex within the context of the final installation of the vehicle door.

The present invention is concerned with the problem of indicating possibilities for an assembly support of the type mentioned at the beginning, by means of which the production of the vehicle door is simplified.

This problem is solved according to the invention by the subject matters of the independent claims. Advantageous embodiments are the subject matter of the dependent claims.

The present invention is based on the general concept of designing the assembly support and the locking system in such a manner that the adjustment and testing of the locking system can be carried out during the assembly of the assembly support. By shifting the adjustment and testing of the functioning of the locking system to the manufacturing process of the assembly support, at least the assembly of the vehicle door is simplified since an operable locking system is already present when the assembly support is fitted. In addition, more favorable space conditions which simplify the adjustment of the locking system are present when the assembly support has not yet been fitted into the body shell.

In one development, the outside actuating unit can be designed in such a manner that its outside door handle, with the assembly support fastened to the body shell, can be fastened from an outer side of the vehicle door to the outside actuating unit. This construction simplifies the passing of the locking system through the outer skin of the vehicle door. In addition, the separate mountability of the outside door handle makes it possible not to attach the outside door handle until towards the end of the assembly process, thus reducing the risk of damage to the outside door handle during the installation.

Of particular advantage is a development in which a reference outside door handle representing, as it were, a tolerance-free ideal state is used for adjusting and testing the locking system. Standard outside door handles which have usual manufacturing tolerances are then used for fitting to the vehicle door. However, the tolerances of the standard outside door handles are sufficiently small in order, for the locking system tested with the reference outside door handle, to be able to ensure that the locking system will function correctly after the standard outside door handle has been fitted.

For the adjustment and testing of the functioning of the locking system, it is expedient to transfer the lock unit and the outside actuating unit in each case into a reference position. These reference positions are intended here to correspond essentially to the fitted position of these components and to be present when the door is completed. Depending in each case on the relative position between the lock unit and the outside actuating unit, it is possible for different means of adjustment to be produced to ensure correct functioning of the locking system, for example, when a Bowden cable is used as the operative connection. The adjustment and testing in reference positions makes it possible to ensure that the locking system will be operable for the final state when the vehicle door is completed. In order to transfer the lock unit and the outside actuating unit into their reference positions, a special adjusting and testing device can be provided, which device has suitable aligning elements for aligning the lock unit and the outside actuating unit. With the aid of an adjusting and testing device of this type, the adjustment and testing of the locking system can be considerably simplified.

Further important features and advantages of the invention are apparent from the dependent claims, from the drawings and from the associated description of the figures with reference to the drawings.

It goes without saying that the features mentioned above and those which have yet to be explained below can be used not only in the respectively stated combination, but also in other combinations or on their own without departing from the scope of the present invention.

One preferred exemplary embodiment of the invention is illustrated in the drawings and is explained in greater detail in the following description, in which identical reference numbers relate to identical or functionally identical or similar components.

### BRIEF DESCRIPTION OF THE DRAWINGS

FIG. 1 shows a side view of a vehicle door which is partially assembled and in which an assembly support according to the invention is fitted, and

FIG. 2 shows a perspective view of a section of the assembly support, in which components of a locking system are arranged.

### DETAILED DESCRIPTION OF THE INVENTION

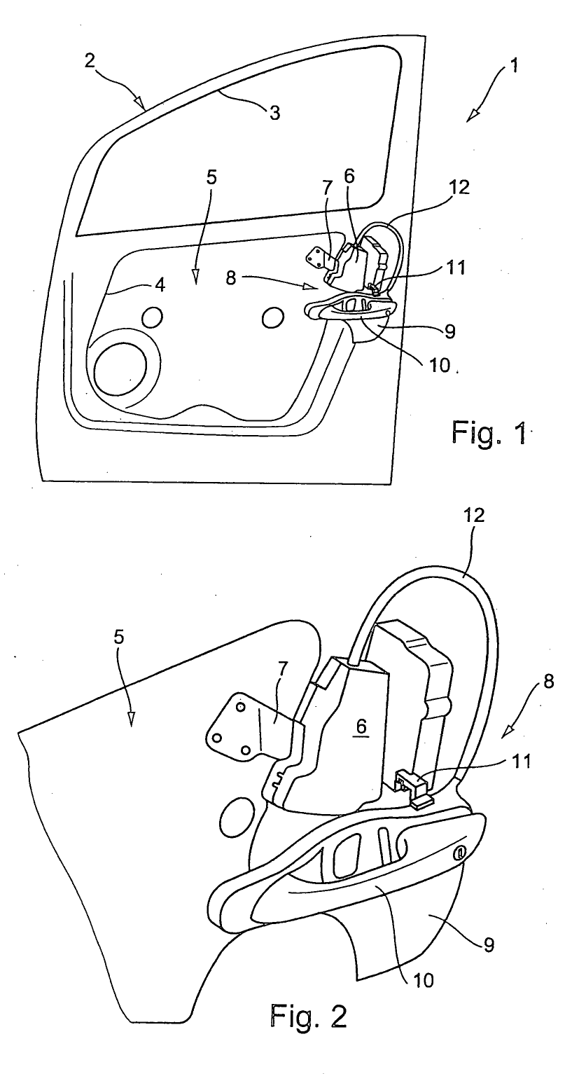

According to FIG. 1, a vehicle door 1 of a motor vehicle (not illustrated), in particular of a passenger vehicle, has a body shell 2 which contains a window opening 3 and an installation opening 4. The installation opening 4 is closed by an assembly support 5 according to the invention which is fitted into the body shell 2. For this purpose, the assembly support 5 is fastened, in particular screwed or clipped, to the body shell 2, for example from an inner side of the vehicle door 1 that faces away from the observer. A lock unit 6 of a locking system 8 is fastened to the assembly support 5, use being made here, in order to connect the lock unit 6 to the assembly support 5, of a first adaptor 7 via which the lock unit 6 is indirectly fastened to the assembly support 5. In the fitted state of the assembly support 5, the lock unit 6 may additionally also be fastened directly to the body shell 2.

In addition, the locking system 8 has an outside actuating unit 9 and an outside door handle 10. When a vehicle door 1 is completed, the outside door handle 10 is arranged on an outer side of the vehicle door 1 facing the observer, serves to introduce opening forces into the locking system 8, is situated, when the vehicle door 1 is completed, on the outer side of an outer skin of the body shell 2, where it penetrates said outer skin, and, in the interior of the vehicle door 1, is mounted on the outside actuating unit 9 which is accordingly arranged on the inner side of the outer skin of the body shell 2.

According to the present invention, the outside actuating unit 9 is fastened to the assembly support 5 and/or to the lock unit 6. In the present case, the outside actuating unit 9 is fastened via a second adaptor 11 to the lock unit 6 and therefore indirectly also to the assembly support 5. For the outside actuating unit 9, provision may also be made for the latter to be fastened to the body shell 2 after or together with the fitting of the assembly support 5 into the body shell 2. The lock unit 6 and the outside actuating unit 9 are coupled to each other via an operative connection 12, which is formed here by a Bowden cable.

It is clear that the locking system 8 may comprise further components (not illustrated here), in particular an inside actuating unit, with the aid of which the lock unit 6 can be actuated from the inner side of the door in order to open it, a corresponding operative connection between the lock unit 6 and the inside actuating unit then also being provided. In addition, a remote actuating unit which is coupled to the lock unit 6 in a corresponding manner or is integrated therein may be provided.

In addition, the assembly support 5 may also be used for the fastening of further assemblies, such as, for example, window opening mechanisms and/or speakers.

Since, when the vehicle door 1 is assembled, the outside actuating device 9 is situated on the inner side of the outer skin of the body shell 2 while the outside door handle 10 is arranged on the outer side of the outer skin, in the case of the assembly support 5 according to the invention a simplification of the assembly of the vehicle door 1 can be achieved by the fact that the outside door handle 10 can be fastened to the outside actuating unit 9 from the outer side of the vehicle door 1, i.e. through the outer skin of the body shell 2. This fastening is expediently designed here in a manner such that it can be released in order, when the vehicle door 1 is completed, to be able to remove the outside door handle 10 for maintenance work and repairs.

According to FIGS. 1 and 2, the connection of the lock unit 6 to the assembly support 5 is designed in such a manner that the lock unit 6 can be positioned relative to the assembly support 5 within a predetermined range of tolerances. This positioning capability can be obtained, in particular, by an appropriate configuration of the first adaptor 7. The connection of the outside actuating device 9 to the lock unit 6 is expediently also designed in such a manner that here too the outside actuating device 9 can be positioned relative to the lock unit 6 within a predetermined range of tolerances. This positioning capability can also be realized in a particularly simple manner by an appropriate configuration of the second adaptor 11.

The construction proposed according to the invention enables the two components which are coupled to each other by the operative connection 12, namely the lock unit 6 and the outside actuating unit 9, to be attached to the assembly support 5, as a result of which it is possible, using suitable measures, to check the reliable functioning of the locking system 8 and to produce and/or optimize it, if appropriate by means of suitable adjustments.

For the assembly of the vehicle door 1 the procedure can preferably be as follows:

Within the context of a preassembly process, the assembly support 5 is produced and fitted with the associated assemblies. According to the invention, the assembly support 5 is therefore equipped at least with the lock unit 6 and the outside actuating unit 9. Still within the context of the preassembly process, an adjustment and testing of the locking system 8 mounted on the assembly support 5 can now be carried out. In this case, it is expedient to align the lock unit 6 and the outside actuating unit 9 in predetermined reference positions relative to each other and/or relative to the assembly support 5. This procedure is advantageous if the functioning of the operative connection depends on the relative position between the lock unit 6 and the outside actuating unit 9. It is clear that the reference positions expediently correspond to the desired fitted positions of the lock unit 6 and the outside actuating unit 9, these two components having these positions when the vehicle door 1 is completed. In order to be able to align the lock unit 6 and the outside actuating unit 9 in the desired manner, use can be made of a special adjusting and testing device which has suitable aligning elements for this purpose. For this alignment, the positioning capability, described further above, of the lock unit 6 relative to the assembly support 5 and of the outside actuating unit 9 relative to the lock unit 6 is of advantage, since the setting of the desired reference positions is simplified as a result.

In order to be independent of the manufacturing tolerances during the production of the outside door handles 10, use is expediently made, for the adjustment and testing of the functioning of the locking system 8, of a reference outside door handle which is produced with very small, in particular minimal, tolerances and as a result has, as it were, the desired ideal dimensions. The use of the reference outside door handle makes it possible to ensure that all standard outside door handles 10 produced within the permissible tolerances reliably maintain the correct functioning of the locking system 8 when fitted into the functionally tested locking system 8.

When the lock unit 6 and the outside actuating unit 9 are attached to the assembly support 5, a rough positioning of the lock unit 6 and of the outside actuating unit 9 relative to each other and/or relative to the assembly support 5 takes place. This rough positioning firstly simplifies the above-described alignment of these units 6, 9 for the adjustment and testing of the functioning of the locking system 8. Secondly, the attachment, taking place within the context of a final installation, of the lock unit 6 and/or the outside actuating unit 9 to the body shell 2 can be simplified as a result. When the positionings of the lock unit 6 and the outside actuating unit 9 are matched to the actual fitting conditions, which vary because of manufacturing tolerances, a fine positioning then takes place.

The fitting of the assembly support 5 into the body shell 2 expediently takes place within the context of a final installation of the vehicle door 1, which installation is decoupled, in particular, temporally and locally from the previously described preassembly process of the assembly support 5. For example, the preassembly process of the assembly support 5, including the adjustment and testing of the functioning of the locking system 8, is carried out at a supplier to a vehicle manufacturer. The final installation, i.e. the fitting of the assembly support 5 into the vehicle door 1, then takes place at the vehicle manufacturer. An increased complexity of the preassembled subassemblies makes it possible for the final installation, i.e. the assembly of the vehicle door 1, to be considerably simplified. It is of particular importance in this case that, when the assembly support 5 is fitted into the vehicle door 1, the functional relationship between the outside actuating unit 9 and the lock unit 6 no longer changes, so that the functionality of the locking system 8 that is ensured by the adjustment and testing is retained when the assembly support 5 is fitted into the vehicle door 1, thus enabling a renewed adjustment and testing of the functioning to be basically omitted.

In order to complete the outside actuating unit 9, after the assembly support 5 is fitted into the vehicle door 1 and, if appropriate, after the lock unit 6 and/or the outside actuating unit 9 is fastened to the body shell 2, the outside door handle 10 is fastened from the outer side of the vehicle door 1 to the outside actuating device 9. It is clear that also further, exterior components of the locking system 8, such as, for example, a covering and a base arranged, if appropriate, between the covering and the outer skin of the body shell, can be attached from the outside to the body shell 2 and/or to the outside actuating unit 9.

1-14. (canceled)

15. An assembly support designed for fastening to a body shell of a vehicle door of a passenger vehicle equipped with a locking system comprising:
a lock unit of the locking system fastened to the assembly support, and
an outside actuating unit of the locking system coupled to the lock unit via an operative connection,
wherein the assembly support, when fastened to the body shell, closes an installation opening left open on the body shell, and
wherein the outside actuating unit is fastened to at least one of the assembly support and the lock unit.

16. The assembly support as claimed in claim 15, wherein the outside actuating unit is designed in such a manner that, with the assembly support fastened to the body shell, an outside door handle of the locking system can be fastened from an outer side of the vehicle door through an outer skin of the body shell to the outside actuating unit.

17. The assembly support as claimed in claim 15, wherein the lock unit is fastened to the assembly support by way of a first adaptor.

18. The assembly support as claimed in claim 15, wherein the outside actuating unit is fastened to the at least one of the assembly support and the lock unit by way of a second adaptor.

19. The assembly support as claimed in claim 15, wherein a fastening of the lock unit to the assembly support and/or of the outside actuating unit to the assembly support and/or to the lock unit permits positioning of at least one of the lock unit and the outside actuating unit within a predetermined range of tolerances.

20. The assembly support as claimed in claim 15, wherein functionality of the lock unit, the outside actuating unit and the operative connection is tested and adjusted when the assembly support is finished and has not yet been fitted into the vehicle door.

21. The assembly support as claimed in claim 16, wherein the lock unit is fastened to the assembly support by way of a first adaptor.

22. The assembly support as claimed in claim 16, wherein the outside actuating unit is fastened to the at least one of the assembly support and the lock unit by way of a second adaptor.

23. The assembly support as claimed in claim 16, wherein a fastening of the lock unit to the assembly support and/or of the outside actuating unit to the assembly support and/or to the lock unit permits positioning of at least one of the lock unit and the outside actuating unit within a predetermined range of tolerances.

24. The assembly support as claimed in claim 16, wherein functionality of the lock unit, the outside actuating unit and the operative connection is tested and adjusted when the assembly support is finished and has not yet been fitted into the vehicle door.

25. A method for assembling a vehicle door of a passenger vehicle equipped with a locking system, comprising:
fastening a lock unit of the locking system to an assembly support and an outside actuating unit of the locking system to at least one of the assembly support and the lock unit and coupling the lock unit to the outside actuating unit by way of an operative connection,
adjusting and testing the mounted locking system,
fitting the assembly support into a body shell of the vehicle door in such a manner that the assembly support closes an installation opening of the body shell, and
attaching an outside door handle of the locking system to the outside actuating unit from an outer side of the vehicle door through an outer skin of the body shell.

26. The method as claimed in claim 25, wherein a reference outside door handle is used for adjusting and testing the locking system while, with the assembly support fitted into the body shell, a standard outside door handle is used for attaching to the outside actuating unit.

27. The method as claimed in claim 25, wherein, when the lock unit is fastened to the assembly support and/or the outside actuating unit is fastened to at least one of the assembly support and the lock unit, a rough positioning of the lock unit and the outside actuating device takes place, while, when the assembly support is fitted into the body shell, a fine positioning of the lock unit and the outside actuating unit takes place.

28. The method as claimed in claim 25, wherein the lock unit and the outside actuating unit are transferred in each case into a reference position for adjustment and testing.

29. The method as claimed in claim 28, wherein, for adjustment and testing, use is made of an adjusting and testing device which permits an alignment of the lock unit and of the outside actuating unit in their reference positions.

30. The method as claimed in claim 25, wherein at least one of the lock unit and the outside actuating unit is additionally fastened to the body shell when the assembly support is fitted into the body shell.

31. The method as claimed in claim 25, wherein the adjustment and testing of the locking system takes place during a preassembly process of the assembly support while fitting of the assembly support and attaching of the outside door handle take place during a final installation which is independent or temporally and/or locally decoupled from the preassembly process.

32. An adjusting and testing device for carrying out the method as claimed in claim 29, wherein aligning elements align the lock unit and the outside actuating unit in their reference positions.

33. The method as claimed in claim 26, wherein, when the lock unit is fastened to the assembly support and/or the outside actuating unit is fastened to at least one of the assembly support and the lock unit, a rough positioning of the lock unit and the outside actuating device takes place, while, when the assembly support is fitted into the body shell, a fine positioning of the lock unit and the outside actuating unit takes place.

34. The method as claimed in claim 26, wherein the lock unit and the outside actuating unit are transferred in each case into a reference position for adjustment and testing.
